(19) United States
(12) Patent Application Publication
(10) Pub. No.: US 2024/0119203 A1
(43) Pub. Date: Apr. 11, 2024

(54) CONTINUOUS RESULT COLLECTION SYSTEM OF LICENSE-INDEPENDENT CFD SIMULATION AND DATA-DRIVEN MACHINE LEARNING FOR HYBRID MODELING

(71) Applicant: Korea Electronics Technology Institute, Seongnam-si (KR)

(72) Inventors: In Pyo CHO, Yongin-si (KR); Sang Yub LEE, Yongin-si (KR); Jaekyu LEE, Yongin-si (KR)

(21) Appl. No.: 18/466,271

(22) Filed: Sep. 13, 2023

(30) Foreign Application Priority Data
Oct. 7, 2022 (KR) 10-2022-0129117

(51) Int. Cl. G06F 30/28; G06F 30/27

(52) U.S. Cl. CPC G06F 30/28; G06F 30/27

(57) ABSTRACT

Proposed is a continuous result collection system of license-independent computational fluid dynamics (CFD) simulation and data-driven machine learning for hybrid modeling. The continuous result collection system may include a user input processor configured to receive a 3D resource, a CFD simulation result, and structured data. The system may also include a framework processor configured to establish a database by accumulating data received from the user input processor and to perform hybrid modeling of the CFD simulation and a machine learning model.

### CROSS-REFERENCE TO RELATED APPLICATIONS

This application claims priority to and the benefit of Korean Patent Application No. 10-2022-0129117, filed on Oct. 7, 2022, the disclosures of which are incorporated herein by reference in their entirety.

### BACKGROUND

### Technical Field

The present disclosure relates to a continuous result collection system of license-independent computational fluid dynamics (CFD) simulation and data-driven machine learning for hybrid modeling.

### Description of the Related Technology

Prediction/analysis researches of fluid mechanics are performed 1) through CFD simulation or 2) through data-driven machine learning by internet of things (IOT) sensor data.

### SUMMARY

One aspect is a system for inputting and collecting results of license-independent CFD simulation and a data-driven machine learning model, which can effectively perform hybrid modeling of the CFD simulation and the machine learning model.

Another aspect is a continuous result collection system of license-independent CFD simulation and data-driven machine learning for hybrid modeling which includes: a user input unit configured to receive a 3D resource, a CFD simulation result, and structured data; and a framework device configured to establish a database by accumulating data received from the user input unit and to perform hybrid modeling of the CFD simulation and a machine learning model.

The user input unit includes a 3D resource input unit, and is configured to receive the 3D resource including at least one of 3D geographic information, location information, a 3D shape, and 3D metadata.

The framework device is configured to receive a CFD simulation performance result in a license holding state and to store the result in a CFD result database and a VTK database.

The framework device includes a processing service providing unit configured to provide a CFD simulation interface, and is configured to transmit the CFD simulation performance result through an abstract function implementation and CFD simulation execution function existing in an interface of the processing service providing unit.

The processing service providing unit is configured to periodically re-execute a CFD and to transmit an alarm to a user in case of an execution failure.

The framework device is configured to perform optimization for requirements and a performance time of the CFD simulation by using dimensionality reduction model artificial intelligence.

The framework device is configured to provide an interface for transferring data previously managed by a user with a certain file or a certain database.

The framework device includes a transfer service providing unit in which an abstract function for collecting data exists to fit a user's database or file management situation, and is configured to execute a transfer service through the implemented interface when a script is executed.

The transfer service is configured to be provided in the form of a Linux container and to be supported independently of user system specifications.

According to the present disclosure, it is possible to provide the input framework for collecting the data from the user, to perform complementary modeling in which the CFD simulation and the machine learning model are merged, and to provide the final visualization for the result files being produced through the hybrid modeling technique.

Effects of the present disclosure are not limited to those described above, and other unmentioned effects will be able to be clearly understood by those skilled in the art from the following description.

### BRIEF DESCRIPTION OF THE DRAWINGS

FIG. 1A and FIG. 1B illustrate a continuous result collection system of license-independent CFD simulation and data-driven machine learning for hybrid modeling according to an embodiment of the present disclosure.

FIG. 2 illustrates database transfer service implementation according to an embodiment of the present disclosure.

FIG. 3 illustrates CFD simulation interface implementation according to an embodiment of the present disclosure.

FIG. 4 is a block diagram illustrating a computer system for implementing a method according to an embodiment of the present disclosure.

### DETAILED DESCRIPTION

In case of the CFD simulation, a developer is required to have a deep understanding of CFD and analysis target fields in order to make high-accuracy simulation possible, a simulation execution time varies depending on the fields and purposes, and it is hard to see results within a few days through general computing resources.

In case of the data-driven machine learning, for high-accuracy modeling, the developer is required to have understanding of data analysis and processing techniques rather than the analysis target field itself, and the analysis and development are possible in case that holding data is enough.

The above-described objects and other objects, advantages and features of the present disclosure, and methods for achieving them will be apparent by referring to embodiments to be described in detail with reference to the accompanying drawings.

However, the present disclosure is not limited to the embodiments disclosed below, and it can be implemented in various different forms. However, the embodiments are merely provided to easily inform those of ordinary skill in the art to which the present disclosure pertains of the objects, constitutions, and effects of the present disclosure, and the scope of the present disclosure is defined by the description of the appended claims.

Meanwhile, terms used in the description are to explain the embodiments, but are not intended to limit the present disclosure. In the description, unless specially described on the context, a singular form includes a plural form. The terms “comprises” and/or “comprising” used in the description should be interpreted so that the described constituent element, step, and/or element do not exclude the presence or addition of one or more other constituent elements, steps, operations, and/or elements.

CFD or IOT data should be loaded enough to continuously perform modeling. Therefore, there is a need for database systems capable of periodically collecting data, and among them, CFD simulation mostly requires valid licenses of various kinds, and thus it requires to be license-independently driven. Further, the CFD or IOT data should be visualized through a graph or 3D visualization in order to make the maintenance and repair for the continuous modeling possible.

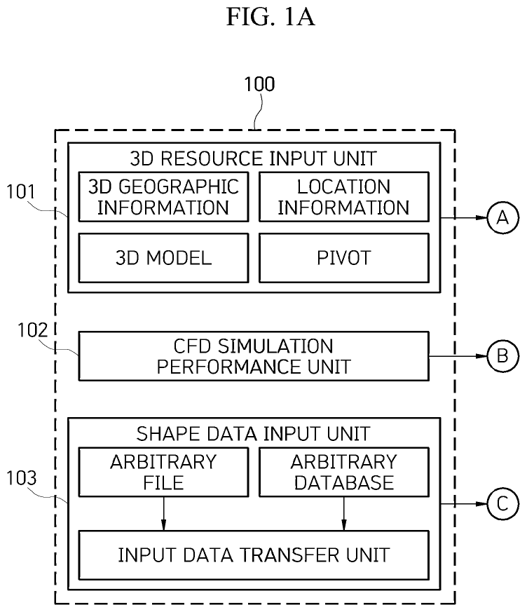

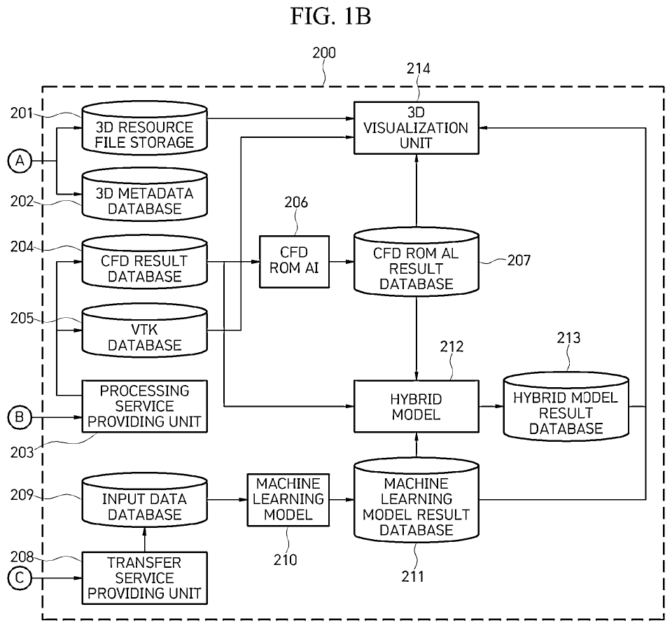

FIG. 1A and FIG. 1B illustrate a continuous result collection system of license-independent CFD simulation and data-driven machine learning for hybrid modeling according to an embodiment of the present disclosure.

Referring to FIG. 1A and FIG. 1B, correlation between a continuous result collection system according to an embodiment of the present disclosure and a required user input is illustrated.

If a required user input is prepared, it is possible for the continuous result collection system according to an embodiment of the present disclosure to provide functions and environments related to database establishment, visualization, and hybrid modeling. A user input unit (or a user input processor) 100 includes a 3D resource input unit 101, a CFD simulation execution unit 102, and a structured data input unit 103. The 3D resource input unit 101 receives 3D geographic information (3D GI), local position information of a generator in geography, a 3D model (3D shape) of a generator, and a pivot (3D metadata) such as origin coordinates of a generator 3D model. Such resources are received in accordance with providing of GUI that can be uploaded (or inputted) in a file unit and in a character string unit, and are stored in a 3D resource file storage 201 and a metadata database 202 of a framework device (or a framework processor) 200. In general, the 3D resources are unnecessary to be frequently inputted, and are completed with the first one input.

The CFD simulation requires a valid license, but is unable to include all licenses due to various simulation tools. Accordingly, in a state where a user holds a license, an interface that is operable in association with the continuous result collection system according to an embodiment of the present disclosure is provided.

The execution result of the CFD simulation execution unit 102 is transferred to a processing service providing unit (or a processing service providing processor) 203, and is stored in a CFD result database 204 and a VTK database 205 in accordance with a periodic call for the CFD simulation.

The structured data input unit 103 provides an interface for supporting data migration to the user in order to migrate data, which has been managed by the user through a file or a certain database system, in the form of a database system and a field defined by the continuous result collection system according to an embodiment of the present disclosure.

A 3D visualization unit 214 implements 3D visualization by merging a 3D resource file stored in the 3D resource file storage 201 and visual data received from the VTK database 205 with each other.

The structured result data by the CFD simulation and the machine learning are visualized as graph-like types, and hybrid modeling is performed with reference to databases of the CFD simulation result and the machine learning result.

In case that data accumulated in the CFD simulation result database 204 exceeds a predetermined level, support of a reduced order model artificial intelligence (ROM AI) is possible. A CFD ROM AI 206 performs optimization for computing requirements and a performance time of the CFD simulation, and the user may selectively use the same at an operable time of the CFD ROM AI 206. Instead of obtaining a gain for the execution time, update of a visual effect (VTK) for the CFD result is not performed.

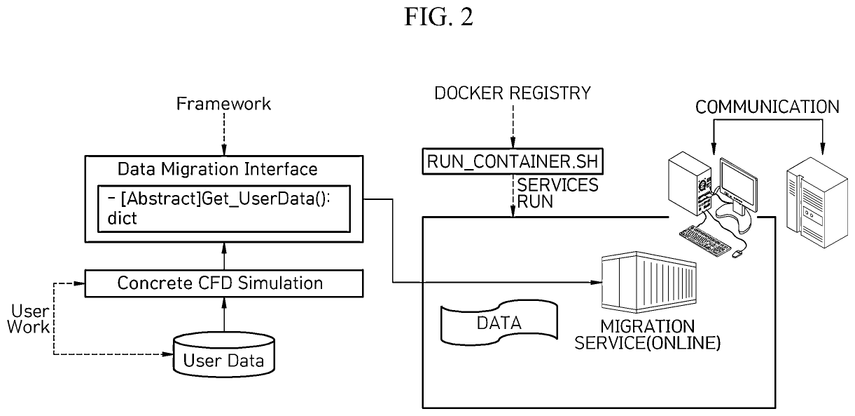

FIG. 2 illustrates database transfer service implementation according to an embodiment of the present disclosure.

According to an embodiment of the present disclosure, a user should continuously transfer IOT data being obtained through a resource, such as a sensor, to a framework.

Since the IOT data may have been managed by a certain file or database system, it is possible to drive a continuous database transfer service through an interface that is provided from the framework according to an embodiment of the present disclosure.

A transfer service providing unit 208 receives user's data through a structured data input unit 103 in accordance with a determined period, and accumulates the received data in an input data database 209. In case that the user transfer service is not in operation due to user's carelessness, the transfer service providing unit 208 transmits an alarm through a mail or the like.

It is possible to continuously connect the database transfer service through an interface module of the transfer service providing unit 208 that is provided by the framework according to an embodiment of the present disclosure. In the interface module of the transfer service providing unit 208, an abstract function (Get_UserData) for collecting data to fit a user's database or file management situation exists. The user should implement this function to fit the user's own data management situation. In case of executing a script that is to periodically collect the user's data with reference to the implemented interface, connection with the framework according to an embodiment of the present disclosure is completed. The transfer service according to an embodiment of the present disclosure is provided in a Linux container form (docker) as independent as possible from user's system specifications (operating system and ISA).

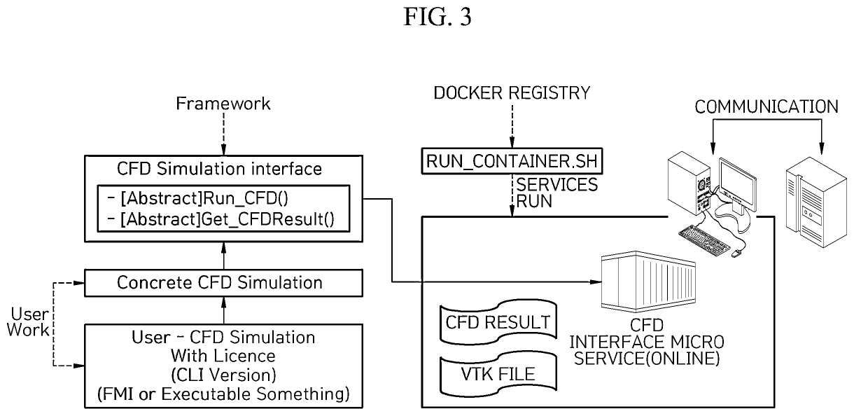

FIG. 3 illustrates CFD simulation interface implementation according to an embodiment of the present disclosure.

According to an embodiment of the present disclosure, as illustrated in FIG. 3, structured result data and visual data that are generated from the CFD simulation are periodically input to the framework. The CFD simulation that is used by the user may be provided by various product developers and distributors, and a valid license is absolutely necessary. Accordingly, it is possible for the user to periodically transmit the result data to the framework according to an embodiment of the present disclosure through the license possessed by the user by completing implementations of abstract functions of an interface module provided by the framework according to an embodiment of the present disclosure.

The user implements the abstract function existing in the interface of the processing service providing unit 203 according to an embodiment of the present disclosure. Through a CFD simulation execution function (Run_CFD), the user executes the CFD simulation to fit the situation through FMI or other executable forms.

According to an embodiment of the present disclosure, an abstract function (Get_CFDResult) for collecting VTK files and CFD structured data is implemented, and a path or data for the final CFD results is returned to fit the user's environment.

The implementation-complete interface is executed in a service form, and is periodically transmitted to the CFD result database 204 and the VTK database 205 through execution of a transfer service that is provided by the framework according to an embodiment of the present disclosure. In order to provide an independent environment to user system specifications (operating system and ISA), the service is provided in a Linux container form (docker).

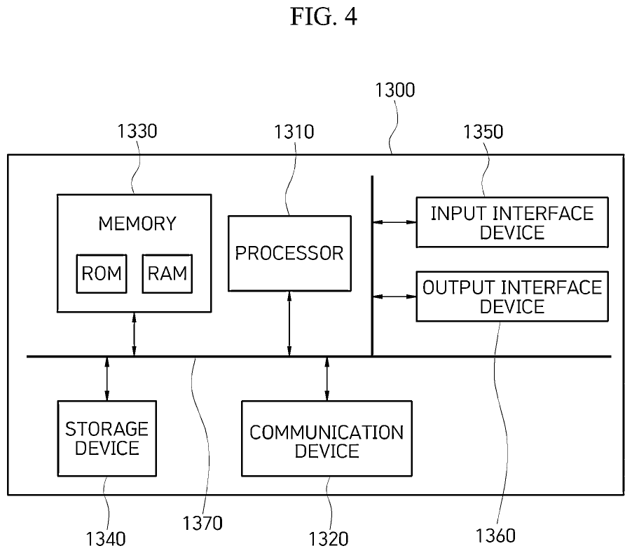

FIG. 4 is a block diagram illustrating a computer system for implementing a method according to an embodiment of the present disclosure.

Referring to FIG. 4, a computer system 1300 may include at least one of a processor 1310, a memory 1330, an input interface device 1350, an output interface device 1360, and a storage device 1340 communicating with each other through a bus 1370. The computer system 1300 may include a communication device 1320 connected to a network. The processor 1310 may be a central processing unit (CPU), or a semiconductor device that executes a command stored in the memory 1330 or the storage device 1340. For example, the memory may include a read only memory (ROM) and a random access memory (RAM). In an embodiment of the present disclosure, the memory may be located inside or outside the processor, and may be connected to the processor through various already known means. The memory is a volatile or nonvolatile storage medium in various forms, and for example, the memory may include a read only memory (ROM) or a random access memory (RAM).

Accordingly, the embodiment of the present disclosure may be implemented as a method implemented in the computer, or may be implemented as a non-transitory computer readable medium storing a computer executable command therein. In an embodiment, when being executed by the processor, the computer readable command may perform a method according to at least one aspect of the present disclosure.

The communication device 1320 may transmit or receive a wired signal or a wireless signal.

Further, the method according to the embodiment of the present disclosure may be implemented in the form of a program command that can be performed through various computer means, and may be recorded in a computer readable medium.

The computer readable medium may include a program command, a data file, and a data structure either alone or in combination thereof. The program command recorded in the computer readable medium may be specially designed and configured for the embodiment of the present disclosure, or may be publicly known to and may be usable by normal technicians in the computer software field. Examples of the computer readable recording medium may include a hardware device configured to store and perform the program command. For example, the computer readable recording medium may be a magnetic medium, such as a hard disk, a floppy disk, or a magnetic type, an optical medium, such as a CD-ROM or a DVD, a magneto-optical medium, such as a floptical disk, a ROM, a RAM, or a flash memory. The program command may include not only a machine language made by a compiler but also a high-level language code that can be executed by a computer through an interpreter.

As described above, although the embodiment of the present disclosure has been described in detail, the scope of the present disclosure is not limited thereto, and various modifications and improvements derived by those skilled in the art using the basic concept of the present disclosure defined in the appended claims should be interpreted as being included in the scope of the present disclosure.

What is claimed is:

1. A continuous result collection system of license-independent computational fluid dynamics (CFD) simulation and data-driven machine learning for hybrid modeling, the system comprising:
a user input processor configured to receive a 3D resource, a CFD simulation result, and structured data; and
a framework processor configured to establish a database by accumulating data received from the user input processor and to perform hybrid modeling of the CFD simulation and a machine learning model.

2. The system of claim 1, wherein the user input processor comprises a 3D resource input processor, and is configured to receive the 3D resource including at least one of 3D geographic information, location information, a 3D shape, or 3D metadata.

3. The system of claim 1, wherein the framework processor is configured to receive a CFD simulation performance result in a license holding state and to store the result in a CFD result database and a visualization toolkit (VTK) database.

4. The system of claim 3, wherein the framework processor comprises a processing service providing processor configured to provide a CFD simulation interface, and is configured to transmit the CFD simulation performance result through an abstract function implementation and CFD simulation execution function existing in an interface of the processing service providing processor.

5. The system of claim 4, wherein the processing service providing processor is configured to periodically re-execute a CFD and to transmit an alarm to a user in case of an execution failure.

6. The system of claim 1, wherein the framework processor is configured to perform optimization for requirements and a performance time of the CFD simulation by using dimensionality reduction model artificial intelligence.

7. The system of claim 1, wherein the framework processor is configured to provide an interface for transferring data previously managed by a user with a certain file or a certain database.

8. The system of claim 7, wherein the framework processor includes a transfer service providing processor in which an abstract function for collecting data exists to fit a user's database or file management situation, and is configured to execute a transfer service through the implemented interface when a script is executed.

9. The system of claim 8, wherein the transfer service is configured to be provided in the form of a Linux container and to be supported independently of user system specifications.
